(19) United States
(12) Patent Application Publication
(10) Pub. No.: US 2004/0147628 A1
(43) Pub. Date: Jul. 29, 2004

(54) Energy curable adduct containing a fluoro group and coatings therefrom

(76) Inventors: Adrian J. Birch, Sint-Jansteen (NL); Alan W Duff, Hulst (NL); Camiel F Bartelink, Terneuzen (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/475,507

(22) PCT Filed: May 7, 2002
(86) PCT No.: PCT/US02/14309

(30) Foreign Application Priority Data
May 7, 2001 (US) 60289344

(51) Int. Cl. C08G 18/00; C08F 2/46

(52) U.S. Cl. 522/174; 528/44

(57) ABSTRACT

Disclosed is a polyfunctional liquid polyurethane-containing adduct wherein the adduct contains as a first functional group at least one structo-terminal polymerizable group and at least one second structo-terminal functional group per molecule which is a fluorinated moiety. Such compounds are useful in radiation curable coatings to modify the surface energy of a substrate.

The present invention relates to compounds which contain both a polymerizable moiety and a fluorinated moiety. Such compounds are useful in radiation curable formulations for modifying the surface energy of a substrate surface.

Fluorochemicals are widely used to modify the surface physical properties of various substrates, such as surface coatings for industrial and residential structures, automobiles, ships and aircraft and as surface-enhancing treatments for textiles, leather and carpets. Fluoro-containing coatings are particularly valuable for their low surface energy and resistance to chemicals, corrosion, and weather.

For examples of various fluorochemicals reported to impart changes in the surface properties of a substrate, particularly for oil and water repellency, see for example, U.S. Pat. Nos. 5,466,770, 3,462,296, 3,849,521, 4,031,637, 4,590,236 and 4,834,764.

Substituted urethane acrylates and methacrylates having an aliphatic backbone having at least one ether or polyether group with at least one pendent fluorinated organic group are disclosed in U.S. Pat. No. 4,508,916. Such compositions, upon radiation polymerization, are disclosed to form a light transmissive material which is well suited to optical applications.

In one aspect, this invention is a polyfunctional liquid polyurethane-containing adduct wherein the adduct contains as a first functional group at least one structo-terminal polymerizable group and at least one second structo-terminal functional group per molecule which is a fluorinated moiety.

In a second aspect this invention relates to an energy curable composition, suitable for coating a substrate which comprises a polyfunctional liquid polyurethane-containing adduct wherein the adduct contains as a first functional group at least one structo-terminal polymerizable group and at least one second structo-terminal functional group per molecule which is a fluorinated moiety, and wherein said adduct is present in an amount of from 0.05 to 99 percent based on total weight of the composition.

In a third aspect this invention is to a process of coating a substrate surface that involves in a first step: applying to a surface of a substrate a composition which comprises a polyfunctional liquid polyurethane-containing adduct wherein the adduct contains as a first functional group at least one structo-terminal polymerizable group and at least one second structo-terminal functional group per molecule which is a fluorinated moiety, and wherein said adduct is present in an amount of from 0.05 to 99 percent based on total weight of the composition; and in a second step, exposing said treated surface to an energy source that can induce polymerization of the composition.

In a fourth aspect, this invention is to an article which comprises a substrate that has adhered to one of its surfaces a polymeric film wherein said article is obtained by the process as mentioned above.

The present invention gives tailored reactive molecules for producing energy curable formulations wherein a fluoro surface modifying agent is bound to the molecule containing the polymerizable group.

The adduct of this invention is characterized in that it is a polyfunctional liquid polyurethane-containing adduct bearing an energy polymerizable group and a second different functional group which is a fluorinated moiety. By the term “liquid” it is meant that the adduct has a pour point of 50° C. or less. Preferably the adduct has a pour point at a temperature of from 0° C. to 40° C.

The polyfunctional liquid polyurethane-containing adduct has a polyol core which is extended with an isocyanate moiety and terminated with at least two functional groups. These functional groups are structo-terminal, that is, they are not pendent, that is, do not hang or branch from the backbone. Statistically, within the same adduct molecule, at least one chain end bears a polymerizable group, and at least one chain end bears a fluorinated group.

The term “polymerizable group” means a moiety that is susceptible to polymerization when exposed to an energy source, optionally in the presence of an initiator. Such energy sources can be, for example, actinic radiation, ultraviolet or electron-beam radiation, or thermal radiation.

The term “fluorinated” group or moiety means a group which contains at least 3 carbon atoms and at least one fluoro moiety.

In a preferred embodiment of this invention, the adduct has on average from 2 to 8, more preferably from 3 to 8, and yet more preferably from greater than 3 to 6 chain ends per molecule, wherein each chain contains one or more urethane linkages. When the adduct contains from 2 to 8 chain ends per molecule; then the adduct can have from 1 to 7 polymerizable moieties per molecule and from 7 to 1 fluorinated moieties per molecule. The optimum ratio of polymerizable moieties to fluorinated moieties will depend on the intended purpose and surface to be coated and can vary within the ranges of from 1:7 to 7:1, and preferably from 1:2 to 2:1.

The polyfunctional liquid polyurethane adducts of the present invention can contain additional functional moieties such as aryl, alkyl, ester, nitrile, alkene, alkyne, halogen, silyl or combinations thereof. The equivalents of polymerizable and fluoro moieties and optionally additional functional groups is such that the adduct is substantially free of any isocyanate functionality or any isocyanate-reactive functionality.

The adducts of the invention are prepared by reaction of an isocyanate-terminated prepolymer with substances containing the polymerizable group and with substances containing the fluorinated moiety. An isocyanate-terminated prepolymer is generally prepared by reacting an excess of an isocyanate with an isocyanate-reactive compound. Materials and processes are described in more detail hereinafter.

The isocyanates which may be used in producing a prepolymer include aliphatic, cycloaliphatic, arylaliphatic and aromatic isocyanates. Advantageously the isocyanates selected are those which have the ability to be removed from crude mixtures through distillation, crystallisation or solvent extraction procedures. Preferred are aromatic and aliphatic polyisocyanates and notably diisocyanates. Such aromatic and aliphatic isocyanates may also be used in admixture when preparing a prepolymer.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether. A preferred isocyanate is toluene-2,4- and 2,6-diisocyanates (TDI).

Examples of aliphatic polyisocyanates include ethylene diisocyanate, 1,6-hexamethylene diisocyanate, 1,4-tetramethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof. Preferably the aliphatic polyisocyanate isophorone diisocyanate is used for prepolymers of the present invention.

Isocyanate-reactive compounds useful in the preparation of the prepolymer include substances bearing a plurality of isocyanate-reactive functional groups per molecule where such functional groups include OH, —SH, —COOH, —NH, where R is a moiety not reactive with an isocyanate group, such as alkyl, alkene, or aryl, preferably a C1 to C6 alkyl. Preferred is when such isocyanate reactive functional group is an-OH functionality. Typically such isocyanate-reactive materials are collectively referred to as polyols. The polyol may contain up to 8 such functional groups per molecule, preferably from 2 to 8, more preferably from 3 to 8, and most preferably from greater than 3 to 6 functional groups per molecule. Advantageously the polyol is a polyether polyol, also known as a polyoxyalkylene polyol, or polyester polyol. Other polyols include polyester polyols, polycaprolactone polyols, polyalkylene carbonate polyols, polyolefinic polyols and polyphosphate-based polyols.

The polyol generally has an equivalent weight of from 100 to 5000. Preferably the polyol has an equivalent weight of from 200 or greater, more preferably from 300 or greater. Preferably the equivalent weight is less than 3000, more preferably less than 2000, and yet more preferably less than 1500. Preferably the polyol is a polyester or polyether polyol. Highly preferred are polyoxyalkylene polyols where the oxyalkylene entity comprises oxyethylene, oxypropylene, oxybutylene or mixtures of two or more thereof. Especially preferred are oxypropylene-oxyethylene mixtures. Processes for making such polyols are known to those in the art.

Suitable polyoxyalltylene polyols are exemplified by various commercially available polyols as used in polyurethane, lubricant, surfactancy applications and include polyoxypropylene glycols designated as VORANOL™ P-2000 and P4000 with respectively equivalent weights of 1000 and 2000; polyoxypropylene-oxyethylene glycols such as DOWFAX™ DM-30 understood to have an equivalent weight of 300 and an oxyethylene content of 65 weight percent, and SYNALOX™ 25D-700 understood to have an equivalent weight of 2750 and an oxyethylene content of 65 weight percent, all available from The Dow Chemical Company; polyoxyethylene triols available under the trademark TERRALOX™ and designated as product WG-98 and WG-116 understood to have a molecular weight of 700 and 980, respectively, polyoxypropylene-oxyethylene triols designated as VORANOL™ CP 1000 and CP 3055 understood to have respectively a molecular weight of 1000 and 3000, and VORANOL™ CP 3001 understood to have a molecular weight of 3000 and an oxyethylene content of 10 weight percent and VORANOL™ CP 6001 understood to have a molecular weight of 6000 and an oxyethylene content of 15 weight percent, all available from The Dow Chemical Company; polyoxypropylene hexols including VORANOL™ RN-482 understood to have a molecular weight of 700, and polyoxyethylene hexols including TERRALOX™ HP-400 understood to have a molecular weight of 975, both available from The Dow Chemical Company; higher functionality polyether polyols including those based on carbohydrate initiators such as, for example, sucrose and exemplified by VORANOL™ 370 available from The Dow Chemical Company. Some of the above polyols have been described by reference to their molecular weight and whether they are difunctional (diol) or trifunctional (triol) and so forth. The equivalent weight of such substances is generally understood as being the numeric result of the molecular weight divided by the nominal functionality.

The isocyanate-terminated prepolymer is generally prepared by the reaction of an excess of polyisocyanate with the polyol under standard conditions known in the art. The polyisocyanate is added at an excess to provide an NCO:OH ratio of 2:1 to 20:1. Preferably the NCO:OH ratio is 3:1 to 10:1. The unreacted isocyanate monomer is removed from the prepolymer by distillation or other treatment to a concentration of less than 3 percent, preferably less than 1 percent, more preferably less than 0.5 percent, and yet more preferably less than 0.1 percent by weight of unreacted polyisocyanate in the prepolymer. The temperatures for effecting reaction between the polyisocyanate and polyol are generally 0° C. to 120° C.

To facilitate the formation of the urethane bond between the isocyanate and polyol, a catalyst may be used. Such catalysts are known in the art and include tertiary amine compounds, amines with isocyanate reactive groups and organometallic compounds.

Alternatively the polyol can be added to the polyisocyanate at a controlled rate, as disclosed in WO 96/34904, the disclosure of which is incorporated herein by reference, to produce prepolymers having low residual free isocyanate monomer. This controlled addition is done under essentially anhydrous conditions, in the absence of a catalyst and maintained temperature of from 20° C. to 80° C.

The preparation of prepolymers as described above reduces the formation of higher oligomers or polyol terminated prepolymers. The formation of oligomers rapidly increases the functionality and viscosity of the prepolymer and can lead to gelation. See for example, WO 96/34904 which describes the formation of oligomers. The prepolymers of the invention are further characterized in that they have a theoretical isocyanate content of from 1 to 16, preferably from 1 to 10, more preferably from 1 to 7 weight percent. Measured isocyanate contents may be higher depending on the residual content of unreacted polyisocyanate.

To obtain an adduct of the present invention, the isocyanate-terminated prepolymer is reacted with isocyanate-reactive substances containing the polymerizable group and with isocyanate reactive substances containing the fluorinated moiety.

Isocyanate-reactive substances containing the fluorinated moiety can be represented by R_{f}X. X refers to an isocyanate-reactive functional group where such functional groups include —OH, —SH, —COOH, —NHR, where R is as previously defined. Preferably the isocyanate reactive functional group is —OH. R_{f} contains at least 3 carbon atoms, preferably 3 to 20 carbon atoms, and more preferably 6 to 14 carbon atoms. R_{f} can contain straight chain, branched chain, or cyclic aliphatic fluorinated groups, aromatic fluorinated groups or combinations thereof. R_{f} can optionally contain catenary heteroatoms such as oxygen, divalent or hexavalent sulfur, or nitrogen. In a preferred embodiment R_{f} contains oxygen. It is preferred that R_{f} contains 40 percent to 80 percent fluorine by weight, more preferably 50 percent to 78 percent fluorine by weight. The terminal portion(s) of the R_{f} group is fully fluorinated, preferably containing at least 7 fluorine atoms, for example, CF₃CF₂CF₂—, (CF₃)₂CF—, —CF₂SF₅, F(CF(CF₃)CF₂—O)₄CF(CF₃)CH₂—. Perfluorinated aliphatic groups and perfluorinated ethers are the most preferred embodiments of R_{f}. Examples of suitable fluorinated moieties include fluorinated alcohols available from DuPont under the trademark KRYTOX and fluoroalkylalcohols under the trademerk ZONYL BA. Other suitable substances are perfluoroethanols as available from Clariant under the trademark FLUOWET and include products designated as FLUOWET EA 812EP, FLUOWET EA 6/1020, and FLUOWET EA-600.

Other examples of fluorochemical agents include, for example, R_{f} containing urethanes, ureas, esters, amines (and salts thereoi), amides, acids (and salts thereof), carbodiimides, guanidines, allophanates, biurets, oxazolidinones, and other substances containing one or more R_{f} groups, as well as mixtures and blends thereof. Such agents are well known to those skilled in the art, see for example, Kirk-Othmer, Encyclopedia of Chemical Technology, 3rd Ed., Vol. 24, pp. 448-451 and many are commercially available as ready-made formulations. Useful fluorochemical agents can be polymers containing multiple R_{f} groups such as copolymers of fluorochemical acrylate and/or methacrylate.

Isocyanate-reactive substances containing the polymerizable moiety are substances which contain a functional group that can polymerize under the influence of an energy source and which additionally contain a functional group that can react with an isocyanate such as described above. The isocyanate reactive substance could also be an isocyanate if it is the intention to couple to the prepolymer by formation of an isocyanurate or carbodiimide linikage.

One type of radiation polymerizable functionality is ethylenic unsaturation which in general is polymerized through radical polymerization such as can be initiated through exposure to actinic radiation, but can also be polymerized through cationic or anionic polymerization. Examples of ethylenic unsaturation are groups containing vinylether, vinyl ester (for example, acrylate or methacrylate) or acrylamide functionality. Preferably, the polymerizable group is a vinyl ester group or a vinylether group. Most preferably, the polymerizable group is an acrylate or methacrylate group.

The polymerizable vinyl ester can be represented by the following formula.

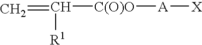

and the vinyl ether can be represented by the formula:

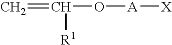

where X is an isocyanate-reactive functional group, such as H, —SH, —COOH or

—NHR where R is as previously defined; R¹ is a substituent comprising hydrogen, a C1 to C3 alkyl or acyl radicals or a halogen or other groups which will not deleteriously affect the curing of the final adducts, and A is an aliphatic or aromatic hydrocarbon segment have 1 to 6 carbon atoms. As it is desirable to have a final product which is a liquid, A and R¹ are selected to give a final product which is a liquid.

Hydroxy functional ethylenically unsaturated monomers are preferred. Preferably A is a C1 to C4 alkyl. More preferably A is a C2 alkyl. Preferably the unsaturated monomer contains vinyl ester, vinylether, maleate or fumarate functionality.

Examples of the (meth)acrylate having a hydroxyl group used in the present invention include 2-hydroxyethyl(meth)acrylate, 2-hydroxypropyl(meth)acrylate, 2-hydroxybutyl(meth)acrylate, 2-hydroxy-3-phenoxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate and such like. Among these (meth)acrylates preferred are 2-hydroxyethyl acrylate, 2-hydroxypropyl acrylate, 2-hydroxyethyl methacrylate, 2-hydroxypropyl methacrylate, diethylene glycol monoacrylate, diethylene glycol monomethacrylate, glycerine dimethacrylate, dimethylol propane dimethacrylate, and reaction products of polyester glycols with acrylic or methacrylic acid. Such compounds are commercially available or can be produced using standard procedures known in the art.

Monomers having vinyl ether functional groups include, for example 4-hydroxybutyl vinyl ether and triethylene glycol monovinyl ether. Monomers having maleate functional groups include, for example maleic acid and hydroxy functional maleates.

The above mentioned isocyanate-reactive substances containing the polymerizable moiety can be also used as a mixture wherein said mixture comprises a blend of two or more such substances.

The adduct of this invention is obtained by a capping reaction of the isocyanate-terminated prepolymer with less than a stoichiometric equivalent of the isocyanate-reactive substance containing the polymerizable moiety of the fluoro moiety and subsequently with a slight stoichiometric excess of the isocyanate-reactive substance containing the other functional group. The excess is in relation to the remaining free isocyanate groups after the first capping step. The stoichiometry is such as to provide for the desired content of moieties. This reaction can be conducted in a sequential manner with either the isocyanate-reactive substance containing the polymerizable moiety or isocyanate-reactive fluorine-containing substance being first reacted with the prepolymer and then in a second step the other being introduced. In a less preferred embodiment the isocyanate-terminated prepolymer can be reacted simultaneously with both of the isocyanate-reactive species.

When capping the isocyanate-terminated prepolymer with the isocyanate reactive substances it may be desirable to control the viscosity of the reactants, process or final adduct. This can be achieved by introducing a “reactive diluent” to the process. Such diluent can be introduced at any stage of the process. By the term “reactive diluent” it is understood a liquid substance which is able to undergo polymerization when exposed to the previously mentioned energy sources yet does not undergo reaction with the isocyanate-terminated prepolymer nor with the isocyanate-reactive substances. Exemplary of suitable reactive diluents are compounds comprising acrylate or methacrylate functionality and characterized by absence of an isocyanate-reactive functionality. Preferred diluents include isoboranol acrylate (IBOA), N-vinyl pyrrolidone, tripropyleneglycoldiacrylate (TPDGA), isopropylacetate and dipropyleneglycoldiacrylate (DPGDA).

Preferably the amount of reactive diluent added is sufficient to give a viscosity of the final adduct solution of between 500 to 2,000 cps. Hydroxyethyl methacrylate (HEMA) may also be used as a reactive diluent. When HEMA is used as reactive diluent, it is intuitively obvious that HEMA can not be used as a reactive diluent until after partial capping of the —NCO groups with the fluoro-containing moiety. After such capping, HEMA is then added in excess so that all the remaining —NCO groups are capped and there is remaining HEMA to act as a diluent.

For addition of a functional group to the isocyanate-terminated prepolymer, the process temperature is chosen for convenience of reaction time and can be greater than 80° C. In general, exposure to a temperature greater than 100° C. should be minimized for the purpose of avoiding undesirable side reactions. The reaction of the isocyanate-terminated prepolymer with a polyfunctional substance can, if desired, be accelerated by use of a suitable urethane-promoting catalyst. Representative of such catalysts are tertiary amine compounds and organotin compounds as used when preparing, for example, polyurethane foam by reaction of a polyisocyanate with a polyol. It is to be noted that use of a catalyst in this can lead to final adducts having a higher viscosity than those prepared in the absence of catalyst.

The energy curable formulation for coating a substrate generally contains other compounds or additives in addition to an adduct of the present invention. Such compositions generally contain from 0.05 to 99 percent by weight of an adduct. Preferably the composition will contain from 0.1 to 50 percent by weight of an adduct. More preferred are compositions which contain from 0.1 to 20 percent by weight of an adduct. Most preferred are compositions which contain 0.1 to 10 percent by weight of an adduct. Such optional additives include light sensitive and light absorbing materials (including U.V. blockers), catalysts, initiators, lubricants, wetting agents, organofunctional silane or silicones, antioxidants and stabilizers.

A photoinitiator is usually required for a UV curable composition, while photoinitiators can usually be eliminated for an electron beam curable composition. The photoinitiator, when used in the composition to initiate radiation cure, provides reasonable cure speed without causing premature gelling of the composition. Examples of free radical photoinitiators are hydroxycyclohexylphenyl ketone, hydroxymethyl phenylpropanone, dimethoxyphenylacetophenone, 2-methyl-1-[4-(methylthio)-phenyl]-2-morpholinopropanone-1,1-(4-isopropylphenyl)-2-hydroxy-2-methylpropane-1-one, 1-(4-dodecylphenyl)-2-hydroxy-2-methylpropan-1-one, 4-(2-hydroxyethoxy)phenyl-2-(2-hydroxy-2-propyl)-ketone, diethoxyphenyl acetophenone, 2,4,6-trimethyl-benzoyl diphenylphosphine.

Another embodiment of the invention is a method of modifying the surface energy of a substrate comprising adding a composition containing the adduct of the present invention to a substrate and then exposing the coated substrate to an energy source, such as ultraviolet radiation. The present invention also encompasses an article comprising a substrate coated with a composition containing an adduct of the present invention in the cured state.

The adducts of this invention have utility as additives for coating formulations to coat substrates such as plastic, metal, natural textiles, synthetic textiles, minerals including glass and wood where it is desirable to take advantage of the surface energy modifications conferred by the presence of the fluorine-containing group. Such advantage can manifest itself through, for example, enhanced stain resistance, enhanced wear resistance, enhanced water repellancy, enhanced slippage (reduced frictional resistance), reduced abrasion, or reduced surface adhesion.

The invention defined above will now be illustrated with reference to the following Examples.

### EXAMPLE I

Preparation of Prepolymer

To a 2-liter glass reactor was added 853.6 grams of isophorone diisocyanate (IPDI) and 0.78 grams of Dabco T-12 (Dibutyltindilaurate, Air Products) catalyst. The mixture, under nitrogen, was heated to a stable temperature of 60° C. and then 668.5 grams of a 6-functional, 303 eq wt EO/PO polyol, 5.6 percent by weight OH, was added at a rate of 5 g/min. Digestion of the reaction mixture continued for 4 hours. After the digestion, 2.0 grams of benzoylchloride was added and the product removed. The recovered material was subjected to a short-path distillation under less than 0.02 mbar, 160° C. The recovered isocyanqate-terminated stripped prepolymer had a free IPDI content of <0.1 weight percent and a measured NCO content of 8.1 weight percent.

Acrylate/Fluoro capping

To a 2-liter glass reactor with air gas flow, at 60° C., was added 775.4 grams of the stripped prepolymer. After the prepolymer stabilized at 60° C., 143.1 grams of tripropyleneglycoldiacrylate (TPGDA) was added. After one hour of mixing and at a stable temperature of 60° C., a capping mixture of 57.86 grams of hydroxyethylacrylate (HEA), 1.48 g of T-12 catalyst and 0.96 grams of hydroquinone monomethylether (4-methoxyphenol or MEHQ) was added over a dosing time of 70 minutes. After a further 2 hours of mixing, 174.2 g of TPGDA was added. The mixture was then stirred for an additional hour maintaining the temperature at 60° C.

To the reactor was then added 368.8 grams of 1H,1H,2H,2H-perfluorooctan-1-ol over a dosing time of 50 minutes. After a further 50 minutes of mixing, an infared spectrum showed there was no free NCO. After a further hour, the final product was removed from the reactor. Analysis showed a free HEA content of <0.1 weight percent and a NCO content of <0.05 weight percent.

Although the invention has been described in detail in the foregoing for the purpose of illustration, it was to be understood that such detail was solely for that purpose and that variations can be made therein by those skilled in the art without departing from the spirit and scope of the inventions.

1. A liquid polyurethane-containing wherein the adduct wherein the adds contains as a first functional group at least one structo-terminal polymerizable group and at least one second structo-terminal functional group per molecule which is a fluorinated moiety, wherein the adduct is derived from a prepolymer which is a NCO terminated polyether polyol and the prepolymer contains less than 1 percent by weight of free polyisocyanate.

2. The adduct of claim 1 in the adduct has 2 to 8 structo-terminal.

3. The adduct of claim 1 wherein polymerizable group is selected from, vinyl ester, vinyl ether or acrylamide functionality.

4. The adduct of claim 3 the polymerizable group is selected from acrylate or methacrylate.

5. The adduct of claim 1 wherein the molar ratio of polymerizable functional groups to fluoro moieties is 2:1 to 1:2.

6. An energy curable formulation for coating a substrate, wherein formulation contains from 0.05 to 99 percent by weight of the adduct of any one of claims 1 to 6.

7. A process of coating a substrate surface comprising applying to the surface of a substrate a formulation of claim 6 and in a subsequent step, exposing the treated surface to an energy source to induce polymerization of the formulation ultraviolet radiation, electron-beam radiation or thermal radiation.

8. the process of claim 7 wherein the energy source is actinic radiation, ultraviolet radiation, electron-beam radiation or thermal radiation.

9. An article prepared by the process of claim 8.

10. A method for making an adduct containing at least one structo-terminal polymerizable group and at least one structo-terminal fluoro group comprising the steps of
(1) mixing a polyol polyol containing isocyanate reactive groups with a polyisocyante at a stoichiometric excess of isocyanate groups to isocyanate groups to form an isocyanate terminated prepolymer,
(2) mixing the prepolymer obtained from step I with am isocyanate-reactive compound containing a polymerizable moiety wherein the number of isocyanate reactive moieties is less than a stoichiometric amount with respect to the isocyanate moieties present on the prepolymer;
(3) mixing the product step 2 with an isocyanate-reactive compound containing a fluoro moiety where the stoichiometric amount of isocyanate-reactive groups is at a slight excess with resect to the number of free isocyanate groups remaining after step 2; and
(4) recovering the product from stop 3.

11. The process of claim 10 wherein the isocyanate-reactive compound containing a fluoro moiety is added in step 2 and the is isocyanate-reactive compound containing a polymerizable groups is added in step 3.

12. The prods of claim 10 or 11 wherein the amount of fee polyisocyanate monomer present after step 1 is less 1 percent of the total prepolymer or the amount of free polyisocyanate monomer present is reduced to less a 1 percent by weight of the prepolymer prior to step 2.

13. The process of claim 122 wherein the polymerizable group is a vinyl ester.
